(19) United States
(12) Patent Application Publication
(10) Pub. No.: US 2020/0049462 A1
(43) Pub. Date: Feb. 13, 2020

(54) DUST CONTROL DEVICE IN A MOBILE WEAPON DISCHARGE STATION

(71) Applicant: Cody B. Jones, Tucson, AZ (US)

(72) Inventor: Cody B. Jones, Tucson, AZ (US)

(21) Appl. No.: 16/527,640

(22) Filed: Jul. 31, 2019

Related U.S. Application Data
(60) Provisional application No. 62/715,651, filed on Aug. 7, 2018.

(51) Int. Cl. F41J 11/02; B01D 46/00; E04H 1/12

(52) U.S. Cl. CPC F41J 11/02; B01D 46/00; E04H 2001/1283; B01D 2279/50; E04H 1/1205

(57) ABSTRACT

A modular mobile shooting station having a HVAC system, and air filtration unit, and a dust control device for use in hot desert and cold areas. A dust control device has an open and a closed position. When it is in the closed position, it forms a compartment around a weapon. The compartment forms a trap to preventing the discharged dust (muzzle blast) from escaping towards a shooter behind a shield, and instead directs the dust out through a shooting opening. The shield is part of the dust control device. The dust control device can be utilized in a mobile station or a stationary firing ground.

### CROSS-REFERENCES TO RELATED APPLICATIONS

This application is a non-provisional application and claims benefit of U.S. Provisional Patent Application No. 62/715,651, filed Aug. 7, 2018, the specification of which is incorporated herein in its entirety by reference.

### FIELD OF INVENTION

The present invention is related to a mobile weapon discharge station. More particularly, it is related to a mobile modular weapon discharge station with a dust control device. The dust control device is designed for safety and health concerns.

### BACKGROUND OF THE INVENTION

Marksmanship is an important part of effective gun use. In order to improve marksmanship, gun users practice shooting at targets. For safety, these targets are positioned in a gun range so as to reduce the danger of hitting non-target items. The two major types of gun ranges are indoor and outdoor (or open).

Outdoor ranges are highly vulnerable to harsh weather conditions. In hot desert land, it is unpractical to shoot in an open range under the sun. For example, in Tucson, Ariz., the summer outdoor temperature reaches over 100° F. and dust storms are common. In the north and northeast regions of the United States, there is often freezing weather. In either very hot, very cold, or very dusty weather conditions, outdoor ranges may be very uncomfortable to users. This discomfort can result in decreased shooting accuracy and less effective practice.

Indoor ranges are generally much more expensive to build than outdoor ranges. Additionally, the enclosed nature of an indoor range can result in amplification of the noise produced by firearm discharge. Furthermore, dust and gas discharge from the firearm may lead to a decrease in air quality within the indoor range. In both military and recreational shooting stations, air quality and dust control are safety and health concerns for shooters. The indoor range also reduces the distance a shooter can practice.

### SUMMARY OF THE INVENTION

The present invention relates to a modular weapon discharge station (100) and more particularly it relates to a modular weapon discharge station (100) with a dust control device (110). Users may comfortably shoot from the weapon discharge station (100) at an outdoor range, thus maximizing comfort while minimizing cost. A HVAC unit (102) keeps the weapon discharge station (100) at comfortable temperature, while an air filtration unit (108) and air ducts (116) provide for good air quality. The weapon discharge station (100) combines the advantages of both indoor and outdoor ranges, while eliminating certain of their respective disadvantages.

While air filtration systems have been used in indoor shooting ranges, the dust control device (110) provides a better way to control a discharged dust. Rather than letting the dust accumulate around the user before purifying the air, the dust control device (110) prevents at least a portion the dust from ever reaching the user. When the dust control device (110) is used in the weapon discharge station (100), it may serve to direct the dust through the shooting opening (104) and directly out of the weapon discharge station (100). Furthermore, the dust control device (110) may serve to reduce the noise level within the weapon discharge station (100) by focusing the sound blast out of the shooting opening (104).

It is an objective of present invention to provide a safety and health protection for shooters in military and/or recreational modular mobile shooting stations. This is accomplished by reducing user exposure to both dust and noise. The present invention can be utilized in mobile or stationary weapon discharge stations.

The present invention, a dust control device, has an open and a closed position. When it is in the closed position, it forms a compartment around a weapon. When the weapon is fired, the compartment forms a trap to prevent the discharged dust (muzzle blast and gasses) from escaping towards a shooter behind a shield. The shield is part of the dust control device.

### BRIEF DESCRIPTION OF THE DRAWINGS

The features and advantages of the present invention will become apparent from a consideration of following detailed description presented in connection with the accompanying drawings in which:

FIG. 1 shows a non-limiting schematic of a device (110) of the present invention.

FIG. 2 shows top view of a non-limiting schematic of the device (110) of the present invention.

FIG. 3 shows a transverse vertical cross-section view of a weapon discharge station (100).

FIG. 4 shows a longitudinal vertical cross-section view of the weapon discharge station (100).

FIGS. 5A-5C show a non-limiting schematic of a device (110) of the present invention with top flap(s) mounted.

FIG. 6 shows an illustration of multiple users inside a weapon discharge station (100) of the present invention.

FIG. 7 shows an illustration of the exterior of a weapon discharge station (100) of the present invention with shooting openings (104) opened and a weapon (300) protruding through one of the shooting openings (104).

FIG. 8 shows an illustration of the exterior of a weapon discharge station (100) of the present invention with shooting openings (104) and a door (112) closed so as to maintain a climate inside the weapon discharge station (100) and prevent dust from entering therein.

FIG. 9 shows an illustration of the interior of a weapon discharge station (100) of the present invention, with benches (106) and stools (107) positioned near the shooting openings (104).

FIG. 10 shows an illustration of an exterior side wall (504) of a weapon discharge station (100) of the present invention with an HVAC unit (102), an air filtration unit (108), and inlet and outlet duct works (106) for the air filtration unit (108)

FIG. 11 shows top and side view illustrations of a removable spent brass deflector (114) of the present invention, along with a deflector track (115) with three screw holes for mounting the track (115) to the wall and four slots to fit the spent brass deflector (114)

FIG. 12 shows a side view illustration of a weapon discharge station (100) of the present invention with a row of shooting openings (104), a row of upper shooting openings (470), and a row of lower shooting openings (460).

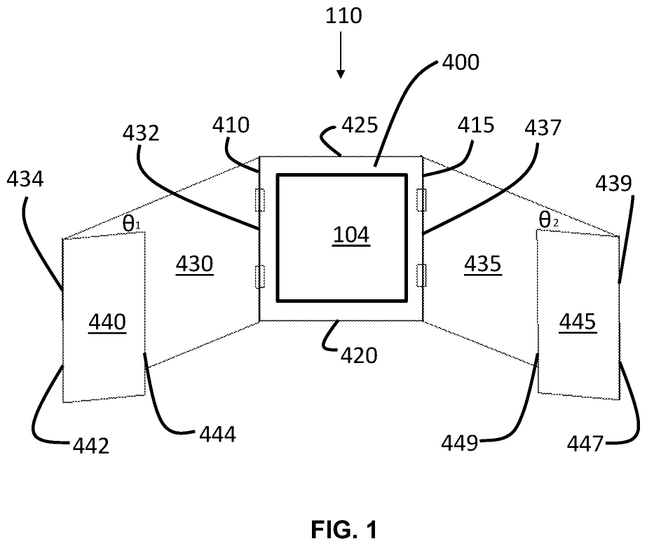

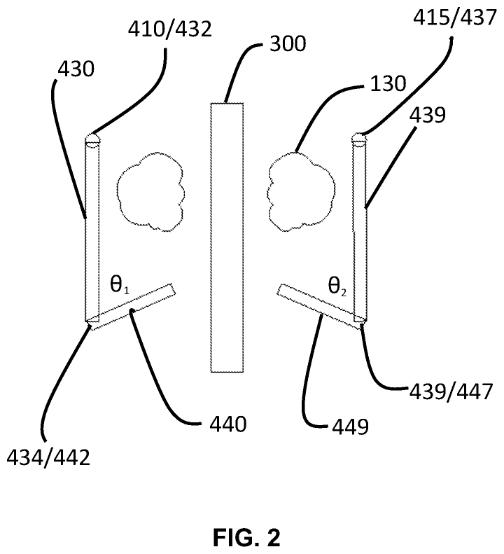

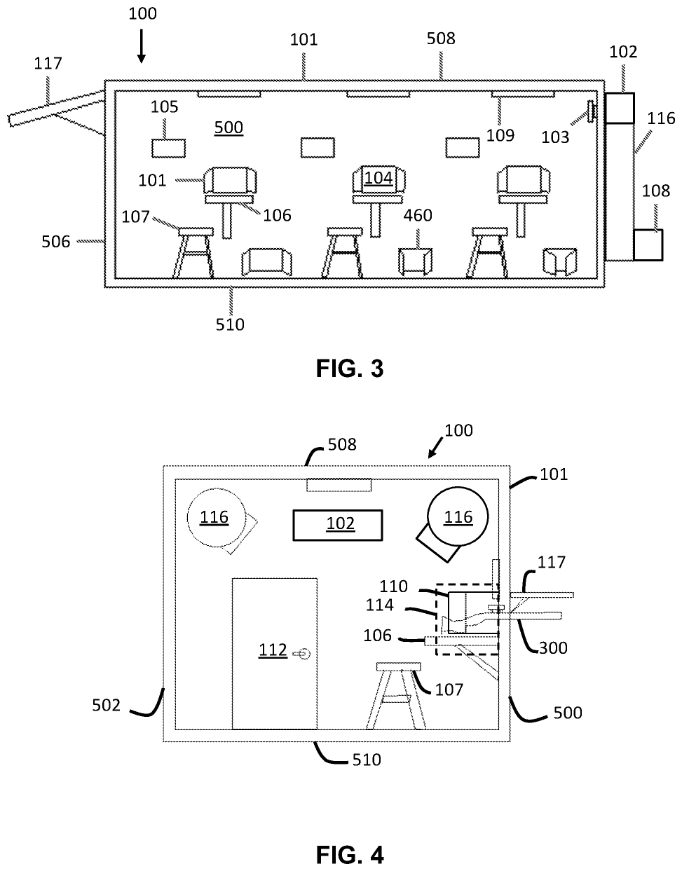

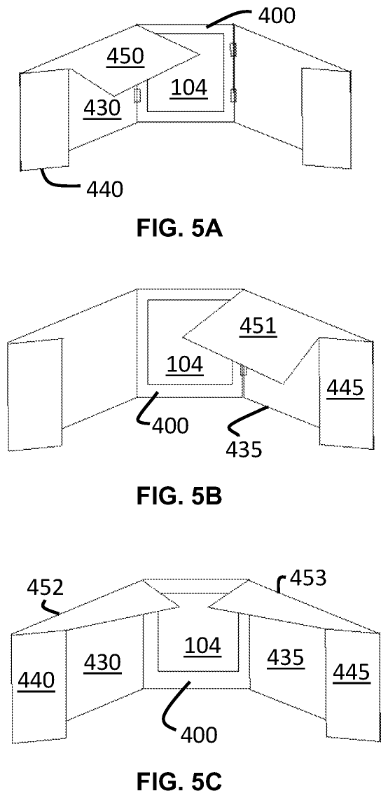

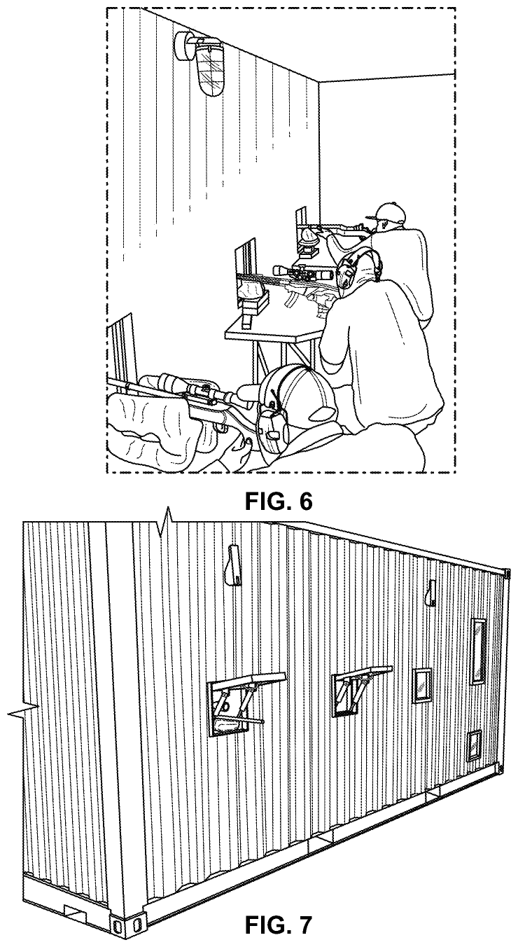

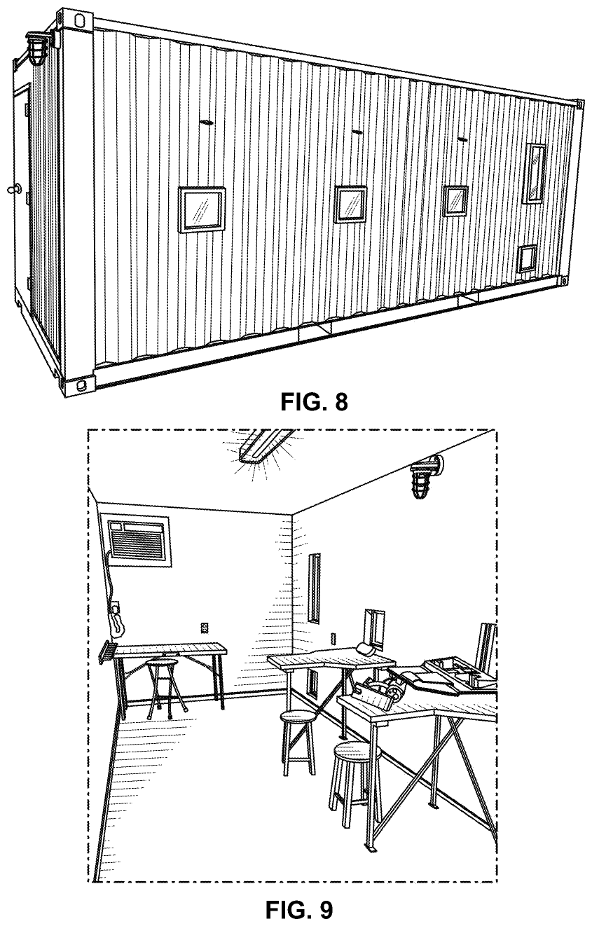

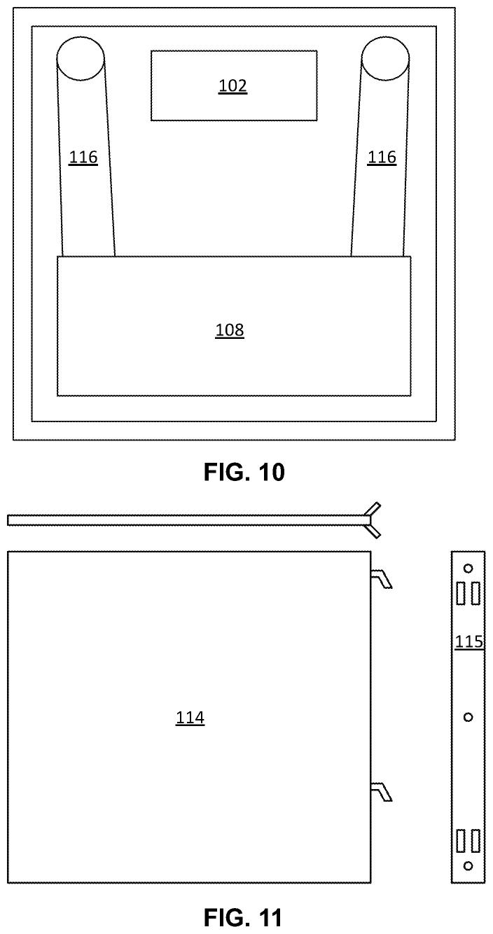

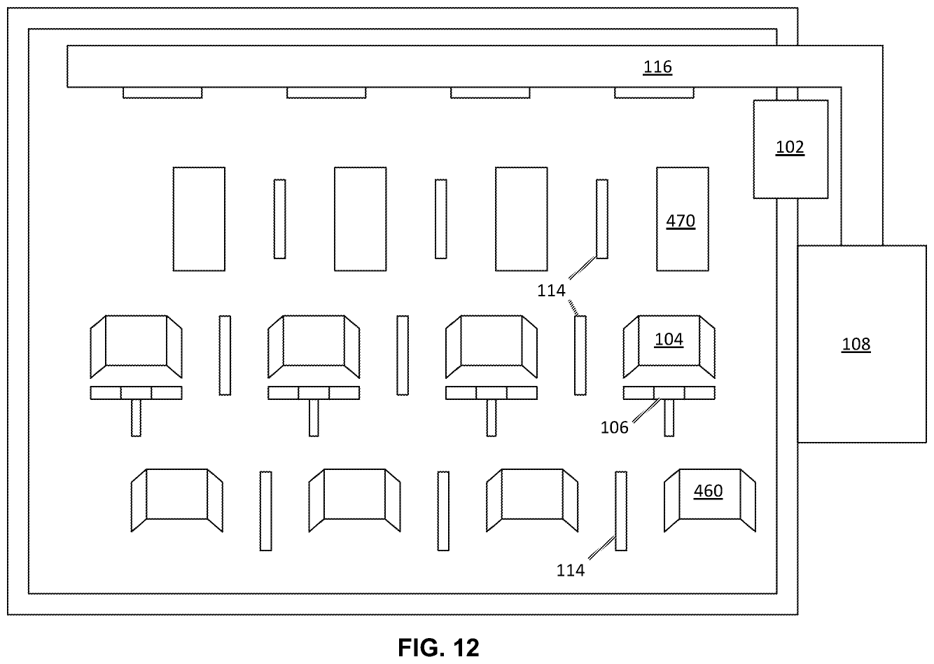

### DETAILED DESCRIPTION OF THE INVENTION

Following is a list of elements corresponding to a particular element referred to herein:

100 weapon discharge station

101 container

102 HVAC unit

103 warning light

104 shooting opening

105 screen

106 bench

107 stool

108 air filtration unit

109 lighting

110 dust control device

111 breaker box

112 door

113 gun rack

114 spent brass deflector

115 deflector track

116 duct work

117 shade

130 discharged dust

300 weapon

400 window frame

410 frame first vertical edge

415 frame second opposing vertical edge

420 frame first horizontal edge

425 frame second opposing horizontal edge

430 first flap

432 first flap proximal edge

434 first flap distal edge

435 second flap

437 second flap proximal edge

439 second flap distal edge

440 first shield

442 first shield proximal edge

444 first shield distal edge

445 second shield

447 second shield proximal edge

449 second shield distal edge

450 first additional flap

451 second additional flap

452 third additional flap

460 lower shooting opening

465 lower window frame

470 upper shooting opening

475 upper window frame

500 front wall

502 back wall

504 first side wall

506 second side wall

508 roof

510 floor

In a broad embodiment, the present invention features a dust control device (110) designed for use in a weapon discharge station (100), the dust control device (110) comprises a window frame (400) with a shooting opening (104), wherein the window frame (400) has a first vertical edge (410), a second opposing vertical edge (415), a first horizontal edge (420) and a second opposing horizontal edge (425).

The shooting opening (104) can be any shape and size. As non-limiting examples, the shooting opening (104) may be square, rectangular, circular, or oval. The width of the shooting opening may be about 6 to 24 inches. The height of the shooting opening may be about 6 to 24 inches. For example, the width may be about 6 to 10 inches, 10 to 14 inches, 14 to 20 inches, or 20 to 24 inches. The height may be about 6 to 10 inches, 10 to 14 inches, 14 to 20 inches, or 20 to 24 inches. Without wishing to limit the present invention to any particular theory or mechanism, it is believed that by reducing the size of the shooting opening, lower noise and better air quality within the container (101) may be achieved. The shooting opening may be at a height so that a seated user may comfortably shoot through it. Alternatively, the shooting opening may be at a height so that a kneeling user may comfortably shoot through it.

In some embodiments, the dust control device (110) comprises a first flap (430) with a first flap proximal edge (432) and a first flap distal edge (434). The first flap proximal edge (432) is pivotally connected to the first vertical edge (410) of the window frame (400). The dust control device (110) further comprise a second flap (435) with a second flap proximal edge (437) and a second flap distal edge (439). The second flap proximal edge (437) is pivotally connected to the second vertical edge (415) of the window frame (400).

The first flap (430) and the second flap (435) are pivotally connected to the window frame (400) by hinges or by other means. The shape of the flaps is affected by the size of the window fame (400). The height of the flaps (430), (435) is the same as that of the window frames (400). In the present invention, the height may be 6 to 24 inches. For example, the height may be about 6 to 10 inches, 10 to 14 inches, 14 to 20 inches, or 20 to 24 inches.

The shape and size of the two flaps can be different or the same. In the present invention, they may be the same. And they may be rectangular. The length may be range from about 12 to 24 inches. The height may be range from about 6 to 24 inches. For example, the length may be about 12 to 16 inches, 16 to 20 inches, or 20 to 24 inches. The height may be about 6 to 10 inches, 10 to 14 inches, 14 to 20 inches, or 20 to 24 inches. The flaps may be flat or curved. As a non-limiting example, the flaps may be curved so as to direct the dust out through the shooting opening.

In some embodiments, the dust control device (110) comprises a first shield (440) with a first shield proximal edge (442) and a first shield distal edge (444). The first shield proximal edge (442) is affixed to the first flap distal edge (434). Therefore, the first flap (430) and the first shield (440) forming an angle θ₁ at where they meet, wherein θ₁ is defined as 0°≤θ₁≤90°. For example, θ₁ may be 30°, 45° or 60°.

In some embodiments, the dust control device (110) comprises a second shield (445) with a second shield proximal edge (447) and a second shield distal edge (449). The second shield proximal edge (447) is affixed to the second flap distal edge (439). Therefore, the second flap (435) and the second shield (445) forming an angle θ₂ at where they meet, wherein θ₂ is defined as 0°≤θ₂≤90+. For example, θ₂ may be 30°, 45° or 60°.

The size and shape of the shields (440), (445) may be the same or different. In the present invent, they may be the same. The height of the shield is the same as that of the flap. It may be 6 inches to 24 inches. The length of the shield is affected by the angle θ₁ and θ₂.

θ₁ and θ₂ may be the same or different. In the present invention, they may be the same. And they may be 30°, 45° or 60°. So, the length of the shield may be 6 to 16 inches Therefore, the height of the shield may be 6 to 24 inches, and the length of the shield may be 6 to 16 inches. For example, the height of the shield may be about 6 to 10 inches, 10 to 14 inches, 14 to 20 inches, or 20 to 24 inches. The length of the shield may be about 6 to 9 inches, 9 to 12 inches or 12 to 16 inches.

Some non-limiting examples of materials for constructing the window fame (400), the first flap (430), the second flap (435), the first shield (440) and the second shield (445) are wood, plastic, aluminium alloy and steel. In the present invention, the window frame (400), the flaps (430, 435) and the shields (440), (445) may be made of wood for easy manufacturing.

The thickness of the flaps (430), (435) and shields (440) (445) may be about 0.25 to 2 inches. The thickness of the window frame may be 3 to 6 inches. For example, in the present invention, the thickness of the flaps (430), (435) and shields (440), (445) may be about 0.25 to 0.5 inches, 0.5 to 0.75 inches, 0.75 to 1 inches, 1 inch to 1.5 inches, 1.5 inches to 2 inches, or more than 2 inches. The width of the window may be about 3 to 4 inches, 4 to 5 inches, 5 to 6 inches, or more than 6 inches.

In some embodiments, the dust control device (110) has an open and a closed position. the dust control device (110) is at the open position when the first shield distal edge (444) and the second shield distal edge (449) swing away from each other to a degree that the first shield distal edge (444) and the second shield distal edge (449) have a maximum distance.

In some embodiments, the dust control device (110) is in the closed position when the first shield distal edge (444) and the second shield distal edge (449) swing towards each other to a degree that the first shield distal edge (444) and the second shield distal edge (449) have a minimal distance. When the dust control device (110) is at the closed position, the dust control device forms a compartment to contain a discharged dust (130) from escaping towards a shooter positioned behind the first and the second shield.

In some embodiments, a first additional flap (450) is mounted onto top of the first flap (430) and/or the first shield (440), so that when the dust control device is closed, it forms the compartment.

The size of the first additional flap (450) may be 18×12 or other size depending on the final size of the first flap (430) and first shield (440). For example, the first additional flap (450) may be 12×6, 14×8, 16×10 or 18×12 inches in size.

In some embodiments, a second additional flap (451) is mounted onto top of the second flap (435) and/or the second shield (445), so that when the dust control device is closed, it forms the compartment.

The size of the second additional flap (451) may be 18×12 or other size depending on the final size of the second flap (435) and second shield (445). For example, the second additional flap (450) may be about 12×6, 14×8, 16×10 or 18×12 inches in size.

In some embodiments, a third additional flap (452) is mounted onto top of the first flap (430) and/or the first shield (440), and a fourth additional flap (453) is added onto top of the second flap (435) and/or second shield (445), so that when the dust control device is closed, it forms the compartment.

The shape and size of the third additional flap (452) and the fourth additional flap (453) are determined by the first flap (430), the second flap (435) the first shield (440), the second shield (445), θ₁ and θ₂. In the present invention, they may be 18×6 inches or other size depending on the size of flaps (430), (435), shields (440), (445), θ₁ and θ₂. For example, they may be about 12×3, 14×4, 16×5 or 18×6 inches in size.

Non-limiting examples of building materials for the additional first, second, third and fourth flap include wood, plastic, aluminium alloy and sheet metal. Efforts are made to reduce the weight of these flaps. In the present invention, wood may be used for easy manufacturing. The thickness of the first additional flap (450), the second additional flap (451), the third additional flap (452) and the fourth additional flap may be 0.25 to 1 inches. For example, they may be about 0.25 to 0.5 inches, 0.5 to 0.75 inches, 0.75 to 1 inch in thickness.

In some embodiments, the first shield distal edge (444) and the second shield distal edge meet with each other forming the compartment with a hole for a weapon (300). The diameter of the hole may be 6 to 12 inches. For example, the diameter may be about 6 to 8 inches, 8 to 10 inches, 10 to 12 inches.

In some embodiments, the first shield proximal edge (442) is adjustably affixed to the first flap distal edge (434). The second shield proximal edge (447) is adjustably affixed to the second flap distal edge (439).

In another broad embodiment, the present invention features a weapon discharge station (100) comprises a container (101) that has a front wall (500), an opposing back wall (502), a first side wall (504), an opposing second side wall (506), a roof (508), and a floor (510). The container (101) may be mobile or semi-mobile. For example, the container (101) may comprise a box container, a prefabricated shed, a modified trailer, or a modified vehicle.

The container (101) may be made of, but not limited to, steel, aluminium alloy, wood, plastic, or mix of these materials. As one non-limiting example of the present invention, a 40 ft shipping container may be converted to as a weapon discharge station (100).

In some embodiments, the window frame (400) is disposed on the front wall (500) of the weapon discharge station (100). There may be a bench (106) adjacent to and beneath a first horizontal edge (420) of the window frame (400). There may be a stool (107) positioned under the bench (106).

In some embodiments, the front wall (500) of the weapon discharge station (100) further has a lower shooting opening (460) adjacent to the floor (510) so that the shooter can lay down while shooting through the lower shooting opening (460). The lower shooting opening (460) may also comprise a dust control device (110).

In some embodiments, the front wall (500) of the weapon discharge station (100) further has an upper shooting opening (470), higher than the shooting opening (104) so that the shooter can stand up while shooting through the upper shooting opening (470). The upper shooting opening (470) may also comprise a dust control device (110).

In some embodiments, the weapon discharge station (100) further comprises an LCD screen (105) for a camera down range focused on a target. The LCD screen (105) is mounted on an interior side of the front wall (500) and adjacent to the window frame (400).

In some embodiments, the front wall (500) of the weapon discharge station (100) has a plurality of shooting openings (104) with window frames (400) and lower shooting openings (460) with lower window frames (465).

In some embodiments, the weapon discharge station (100) further comprises a HVAC mechanical unit (102) mounted on an exterior side of the first side of the wall (504), or a mini split HVAC system, depending on the size of the weapon discharge station (100). A duct (116) may be operatively connected to either the HVAC unit (102) or an air filtration unit (108). The duct (116) is mounted on the interior side of the back wall (502) and under the roof (508). The HVAC system may be ductless.

The air filtration unit (108) may be a single stage, double stage, or triple stage unit. As non-limiting examples, the air filtration unit (108) may comprise a prefilter, a MERV 8 filter, or a HEPA filter. The air filtration system may use a positive air vent and a return air vent to connect the air filtration unit (108) with the container (101) so as to form a closed loop air filtration system.

The weapon discharge station (100) may include one or more spent brass deflectors (114). For example, the spent brass deflectors (114) may be positioned between the shooting openings (104) so as to protect the users from their neighbour's discharged brass. Additionally, the spent brass deflectors (114) may help to reduce noise or lower dust levels. The spent brass deflectors (114) may be removable. As a non-limiting example, the spent brass deflectors (114) may be configured to fit into slots in a deflector track (115). The deflector track (115) may have screw holes so as to allow for easy fastening of the track within the container. Having the ability to easily remove the spent brass deflectors (114) may provide for a wider field of vision when the spent brass deflectors (114) are not needed.

In some embodiments, the weapon discharge station (100) further comprises a red warning light (103) for safety. The red warning light (103) is mounted on the interior side of the first side of the wall (504), an overhead lighting (109) mounted on the interior side of the roof (508), an electric breaker box (111) mounted on the exterior side of the first side of the wall (504), a door (112) mounted on the second side of the wall (506) and a gun rack (113) placed on the floor inside of the weapon discharge station (100).

The weapon discharge station (100) may be significantly quieter than an indoor range. For a non-limiting example, the weapon discharge station (100) may be about 5, 10, 15, 20, 25, 30, 35, 40, 45, or 50 dB quieter than an indoor range when a weapon (300) is fired therein. Without wishing to limit the present invention to any particular theory or mechanism, this noise reduction is believed to me partially because the muzzle break may extend out through the shooting opening (104), or partially because of the dust control device (110) which directs dust and sound out through the shooting opening (104)

In some embodiments, the weapon discharge stations (100) are stacked on top of each other or placed on the side of each other.

As used herein, the term “about” refers to plus or minus 10% of the referenced number.

Various modifications of the invention, in addition to those described herein, will be apparent to those skilled in the art from foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference number recited in the below claims are solely for ease of examination of this patent application, and are exemplary, and are not intended in any way to limit the scope of the claims to the particular features having the corresponding reference numbers in the drawings. In some embodiments, the figures presented in this patent application are drawn to scale, including the angles, ratios of dimensions, etc. in some embodiments, the figures are representative only and the claims are not limited by the dimensions of the figures. In some embodiments, descriptions of the invention described herein using the phrase “comprising” includes embodiments that could be “consisting of” and as such the written description requirement for claiming one or more embodiments of the present invention using the phrase “consisting of” is met.

What is claimed is:

1. A dust control device (110) for use in a weapon discharge station (100), the dust control device (110) comprising:
(a) a window frame (400) with a shooting opening (104), the window frame (400) has a first vertical edge (410), a second opposing vertical edge (415), a first horizontal edge (420) and a second opposing horizontal edge (425);
(b) a first flap (430) with a first flap proximal edge (432) and a first flap distal edge (434), wherein the first flap proximal edge (432) is pivotally connected to the first vertical edge (410) of the window frame (400);
(c) a second flap (435) with a second flap proximal edge (437) and a second flap distal edge (439), wherein the second flap proximal edge (437) is pivotally connected to the second vertical edge (415) of the window frame (400);
(d) a first shield (440) with a first shield proximal edge (442) and a first shield distal edge (444), wherein the first shield proximal edge (442) is affixed to the first flap distal edge (434), the first flap (430) and the first shield (440) thereby forming an angle θ₁ at where they meet, wherein θ₁ is defined as 0°≤θ₁≤90°; and
(e) a second shield (445) with a second shield proximal edge (447) and a second shield distal edge (449), wherein the second shield proximal edge (447) is affixed to the second flap distal edge (439), the second flap (435) and the second shield (445) thereby forming an angle θ₂ at where they meet, wherein θ₂ is defined as 0°≤θ₂≤90°;
wherein, the dust control device (110) has an open position and a closed position, the dust control device (110) is at the open position when the first shield distal edge (444) and the second shield distal edge (449) swing away from each other to a degree that the first shield distal edge (444) and the second shield distal edge (449) have a maximum distance;
wherein the dust control device (110) is in the closed position when the first shield distal edge (444) and the second shield distal edge (449) swing towards each other to a degree that the first shield distal edge (444) and the second shield distal edge (449) have a minimal distance;
wherein when the dust control device (110) is in the closed position, the dust control device forms a compartment to contain a discharged dust (130) from escaping towards a shooter positioned behind the first and second shield.

2. The dust control device of claim 1, wherein the compartment is configured to direct the discharged dust (130) through the shooting opening (104).

3. The dust control device of claim 1, wherein a first additional flap (450) is mounted onto top of the first flap (430) and the first shield (440), so that when the dust control device is closed, it forms the compartment.

4. The dust control device of claim 1, wherein a second additional flap (451) is mounted onto top of the second flap (435) and the second shield (445), so that when the dust control device is closed, it forms the compartment.

5. The dust control device of claim 1, wherein a third additional flap (452) is mounted onto top of the first flap (430) and the first shield (440), and a fourth additional flap (453) is added onto top of the second flap (435) and second shield (445), so that when the dust control device is closed, it forms the compartment.

6. The dust control device of claim 1, wherein the first shield distal edge (444) and the second shield distal edge meet with each other forming the compartment with a hole for a weapon (300).

7. The dust control device of claim 1, wherein the first shield proximal edge (442) is adjustably affixed to the first flap distal edge (434).

8. The dust control device of claim 1, wherein the second shield proximal edge (447) is adjustably affixed to the second flap distal edge (439).

9. A low-noise, low-dust weapon discharge station (100) comprises:
(a) a modular container (101) that has a front wall (500), an opposing back wall (502), a first side wall (504), an opposing second side wall (506), a roof (508), and a floor (510);
(b) a shooting opening (104) in the front wall (500), having a window frame (400);
(c) a dust control device (110) disposed around the window frame (400); and
(d) a bench (106) adjacent to and beneath a first horizontal edge (420) of the window frame (400);
wherein the weapon discharge station (100) is configured to direct dust and sound through the shooting opening (104) so as to reduce dust and noise levels inside the container (101).

10. The weapon discharge station (100) of claim 9, wherein the front wall (500) further has a lower shooting opening (460) adjacent to the floor (510), configured so that the shooter can lay down while shooting through the lower shooting opening (460).

11. The weapon discharge station (100) of claim 10, wherein the lower shooting opening (460) also comprises the dust control device (110).

12. The weapon discharge station (100) of claim 9, wherein the front wall (500) further has an upper shooting opening (470) higher than the shooting opening (104), configured so that the shooter can stand up while shooting through the upper shooting opening (470).

13. The weapon discharge station (100) of claim 9 further comprises an LCD screen (105) for a camera down range focused on a target, wherein the LCD screen (105) is mounted on an interior side of the front wall and adjacent to the window frame (400).

14. The weapon discharge station (100) of claim 9, wherein the front wall (500) has a plurality of window frames (400).

15. The weapon discharge station (100) of claim 9, wherein the front wall (500) has a plurality of lower shooting openings (460).

16. The weapon discharge station (100) of claim 9 further comprises:
(a) a HVAC mechanical unit (102) mounted on an exterior side of the first side of the wall (504);
(b) a red warning light (103) for safety mounted on the interior side of the first side of the wall (504);
(c) a stool (107) positioned under the bench (106);
(d) an overhead lighting (109) mounted on the interior side of the roof (508);
(e) an electric breaker box (111) mounted on the exterior side of the first side of the wall (504);
(f) a door (112) mounted on the second side wall (506); and
(g) a gun rack (113) placed on the floor inside of the weapon discharge station (100).

17. The weapon discharge station (100) of claim 9, wherein the container (101) comprises a converted shipping container.

18. The weapon discharge station (100) of claim 9, wherein the weapon discharge station (100) is about 25 dB quieter than an indoor range when a weapon (300) is fired therein.

19. The weapon discharge station (100) of claim 9, additionally comprising a plurality of spent brass deflectors (114), positioned between the shooting openings (104).

20. The weapon discharge station (100) of claim 9, additionally comprising an air filtration unit (108), connected with the container (101) via a plurality of ducts (116).
